(19) United States
(12) Patent Application Publication
(10) Pub. No.: US 2006/0011201 A1
(43) Pub. Date: Jan. 19, 2006

(54) Modified eye and mouth mask structure for escape from dense smoke of fire accident

(76) Inventor: Tsung-Yuan Ku, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/890,158

(22) Filed: Jul. 14, 2004

(51) Int. Cl. A62B 18/02; A62B 18/08

(52) U.S. Cl. 128/206.19; 128/206.12; 128/206.13

(57) ABSTRACT

An eye and mouth mask structure for escape from dense smoke of fire accident comprises an eye and mouth mask, a liquid bag unit and a package bag unit. The eye and mouth mask and the liquid bag unit are sealed in the package bag unit when not in use. The eye and mouth mask comprises a mouth mask body, an eye mask body and two constriction bands. The eye mask body is connected at the upper side of the mouth mask body. The eye mask body is made of transparent plastic film. The two constriction bands are sewed at end corners of two side peripheries of the mouth mask body for hanging on ears of a user so that the eye mask body and the mouth mask body of eye and mouth mask can cover over his eyes, nose and mouth.

### FIELD OF THE INVENTION

The present invention relates to a modified eye and mouth mask structure for escape from dense smoke of fire accident capable of reducing invasion of dense smoke and, more particularly, to a modified eye and mouth mask structure composed with layers of textile fiber, foam and transparent plastic member; and used at the initial stage of a fire accident to let a user quickly get a mouth mask having a large amount of water to cover over his eyes, mouth and nose, thereby reducing invasion of dense smoke.

### BACKGROUND OF THE INVENTION

Nowadays, the occurrence of fire accident is high, and news about casualty in fire hazards is commonly heard. Generally, the process of a fire accident can be divided into three stages: initial stage, growth stage and maturity stage. In the initial stage of a fire accident, flames take place and a large amount of dense smoke is generated. During the growth and maturity stages, flames start to spread, and the temperature rises quickly. Although most people died in the fire scene are burned black, the real reason of death is not the fire. Instead, most people died in the fire scene were choked to faint by dense smoke generated during the initial stage of the fire accident, or their eyes were invaded by dense smoke so that they couldn't make use of their visual functions to escape from the fire scene. They were not directly burned dead during the growth and maturity stages of the fire accident.

During the initial stage of a fire accident, in order to prevent from inhaling dense smoke, it is necessary for a person at the fire scene to dampen a towel and then cover it over his mouth and nose. However, the path to the water source may be blocked by fire at this time. Even water can be got successfully, some precious time has been wasted to lower the possibility of escape from death, to say nothing of finding a towel and then searching for a water source to dampen it. Meanwhile, the fire may have spread to block all escape paths. Moreover, dense smoke may easily let him be not able to effectively use his visual function of eyes, hence losing the possibility of quick escape from death.

### SUMMARY AND OBJECTS OF THE PRESENT INVENTION

Accordingly, the primary object of the present invention is to provide a modified eye and mouth mask structure for escape from dense smoke of fire accident, which can effectively prevent dense smoke from invading the eyes, nose and mouth of a user during the initial stage of a fire accident to increase the possibility of escape from death.

To achieve the above object, the present invention provides a modified eye and mouth mask structure for escape from dense smoke of fire accident, wherein an eye and mouth mask and a liquid bag unit are together sealed in a package bag unit when not in use. The eye and mouth mask comprises a mouth mask body, an eye mask body and two constriction bands. The eye mask body is connected at the upper side of the mouth mask body. The eye mask body is made of transparent plastic film. The two constriction bands are sewed at end corners of two side peripheries of the mouth mask body. Once a fire accident occurs, the user can break the liquid bag body to let liquid therein flow out so that a damp eye and mouth mask can be got after the package bag is opened. He can then cover the eye and mouth mask over his eyes, nose and mouth to reduce invasion of dense smoke, hence avoiding faint due to smoke choking. He can thus effectively make use of his visual function of eyes to quickly escape from the fire scene.

The various objects and advantages of the present invention will be more readily understood from the following comprehensive description when read in conjunction with the appended drawings, in which:

### BRIEF DESCRIPTION OF THE DRAWINGS

FIG. 1 is a diagram of an eye and mouth mask structure of the present invention before being unsealed;

FIG. 2 is a side cross-sectional view of an eye and mouth mask structure of the present invention before being unsealed;

FIG. 3 is a diagram of an eye and mouth mask structure of the present invention;

FIG. 4 is a diagram of an eye and mouth mask structure according to another embodiment of the present invention; and

FIG. 5 is a bird view of the embodied state of an eye and mouth mask structure of the present invention.

### DETAILED DESCRIPTION OF PREFERRED EMBODIMENT

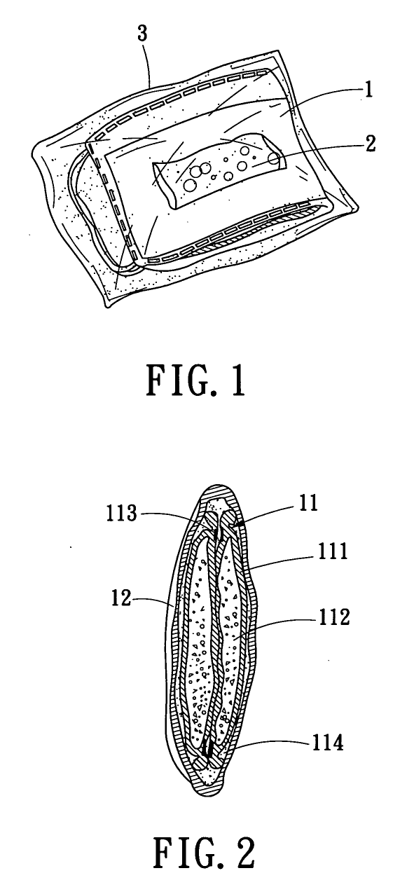

As shown in FIG. 1, the present invention provides a modified eye and mouth mask structure for escape from dense smoke of fire accident, which comprises an eye and mouth mask 1, a liquid bag unit 2 and a package bag unit 3. The eye and mouth mask 1 and the liquid bag unit 2 are sealed in the package bag unit 3 when not in use. The liquid bag unit 2 is a bag unit with liquid (e.g., pure water) loaded therein.

As shown in FIGS. 2 to 5, the eye and mouth mask 1 comprises a mouth mask body 11, an eye mask body 12 and two constriction bands 13. The mouth mask body 11 is made of a foam sponge 112 having a high absorbing and air permeating capabilities. A textile layer 111 then sheathes the foam sponge 112 to let the mouth mask body be able to absorb a large quantity of liquid and have a better air permeating capability. A stop edge 114 is pressed and sealed at the periphery of the mouth mask body 11 to avoid washout of liquid from the periphery of the mouth mask body 11.

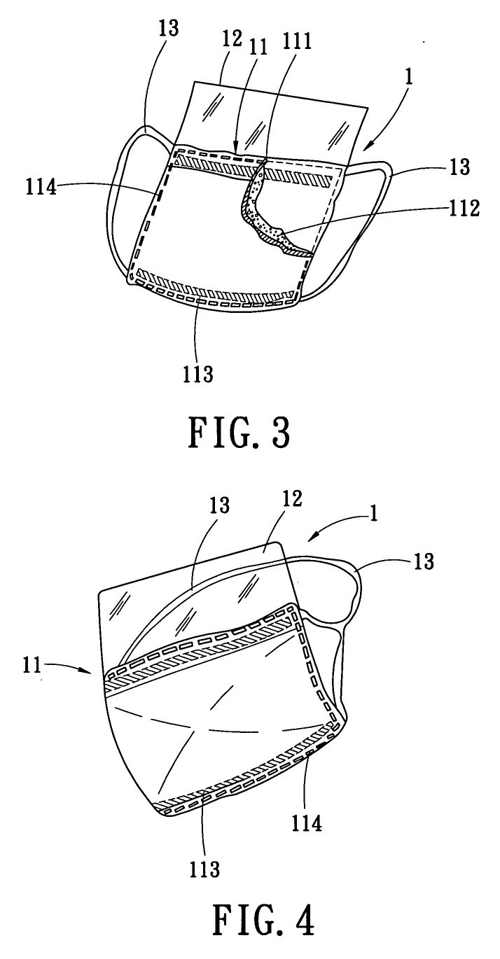

The lower side periphery of the eye mask body 12 is sealed at the upper side periphery of the mouth mask body 11 to let the eye mask body 12 be connected at the upper side of the mouth mask body 11. The eye mask body 12 is made of transparent plastic film. When a user takes out the eye and mouth mask 1 from the package bag unit 3, he first bends the lower periphery of the damp eye mask body 12 to be above the upper side of the mouth mask body 11 (as shown in FIGS. 3 and 4), covers the mouth mask body 11 over his mouth and nose, hangs the constriction bands on his ears, and then sticks the eye mask body 12 with the skin around his eyes, hence letting the region between his eyes and the eye mask body 12 form a closed region not invaded by dense smoke and thus contributing to quick escape from the fire scene.

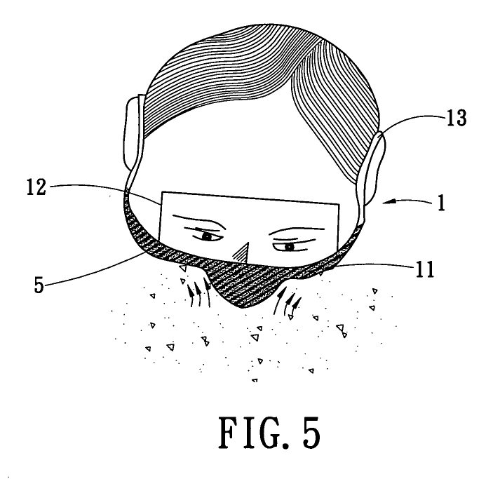

The two constriction bands 13 are sewed at end corners of two side peripheries of the mouth mask body 11 (as shown in FIG. 3) for hanging on the user's ears. The mouth mask body 11 and the eye mask body 12 of the eye and mouth mask 1 can thus cover over his eyes, nose and mouth. Or only a constriction band 13 is sewed at end corners of two side peripheries of the mouth mask body 11 for hanging on the user's head. The mouth mask body 11 and the eye mask body 12 of the eye and mouth mask 1 can also cover over his eyes, nose and mouth. Flexible bars 113 capable of bending and positioning are disposed at upper and lower peripheries of the mouth mask body 11. The flexible bars 113 are plastic bars or soft metallic bars. After the user wears the eye and mouth mask 1, he then presses the upper and lower peripheries of the mouth mask body 11 to adhere the upper and lower peripheries of the mouth mask body 11 to the upper and lower profiles of his face. Therefore, a gap 5 will not form at the periphery of the mouth mask body 11 due to the uneven profile of the user's face to cause dense smoke to invade his eyes, nose and mouth (as shown in FIG. 5).

To sum up, the eye and mouth mask 1 and the liquid bag unit 2 are sealed in the package bag unit 3 when not in use. When a fire accident occurs, the user breaks the liquid bag unit 2 to let liquid therein flow out so that a damp eye and mouth mask 1 can be got after the package bag 3 is opened. He can then cover the eye and mouth mask over his eyes, nose and mouth to reduce invasion of dense smoke, hence avoiding faint due to smoke choking. He can thus effectively make use of his visual function to quickly escape from the fire scene.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A modified eye and mouth mask structure for escape from dense smoke of fire accident, comprising:
an eye and mouth mask comprising a mouth mask body, an eye mask body and two constriction bands, said eye mask body being connected at an upper side of said mouth mask body, said eye mask body being made of transparent plastic film, said two constriction bands being connected at two side peripheries of said mouth mask body;
a liquid bag unit; and
a package bag unit with said eye and mouth mask and said liquid bag unit sealed therein when not in use.

2. The modified eye and mouth mask structure for escape from dense smoke of fire accident as claimed in claim 1, wherein the inside of said mouth mask body is made of a foam sponge, and a textile layer then sheathes said foam sponge.

3. The modified eye and mouth mask structure for escape from dense smoke of fire accident as claimed in claim 1, wherein said mouth mask body is made of a foam sponge.

4. The modified eye and mouth mask structure for escape from dense smoke of fire accident as claimed in claim 1, wherein said mouth mask body is made of a textile layer.

5. The modified eye and mouth mask structure for escape from dense smoke of fire accident as claimed in claim 1, wherein a stop edge is sealed at a periphery of said mouth mask body to avoid washout of liquid from the periphery of said mouth mask body.

6. The modified eye and mouth mask structure for escape from dense smoke of fire accident as claimed in claim 1, wherein an upper side periphery of said mouth mask body seals a lower side periphery of said eye mask body.

7. The modified eye and mouth mask structure for escape from dense smoke of fire accident as claimed in claim 1, wherein said two constriction bands are sewed at end corners of two side peripheries of said mouth mask body.

8. The modified eye and mouth mask structure for escape from dense smoke of fire accident as claimed in claim 1, wherein flexible bars capable of bending and positioning are disposed at upper and lower peripheries of said mouth mask body.
